(19) United States
(12) Patent Application Publication
(10) Pub. No.: US 2019/0360562 A1
(43) Pub. Date: Nov. 28, 2019

(54) Gearless Speed Reducer

(71) Applicant: Orbitless Drives Inc., Vancouver (CA)

(72) Inventor: Leo J. Stocco, Vancouver (CA)

(73) Assignee: Orbitless Drives Inc., Vancouver, BC (CA)

(21) Appl. No.: 16/483,984

(22) PCT Filed: Feb. 5, 2018
(86) PCT No.: PCT/CA2018/050124

§ 371 Date: Aug. 6, 2019

Related U.S. Application Data
(60) Provisional application No. 62/455,484, filed on Feb. 6, 2017.

(51) Int. Cl. F16H 21/12

(52) U.S. Cl. CPC F16H 21/12

(57) ABSTRACT

A gearless drive comprising a reference crankshaft, a high-speed crankshaft, one or more linkages, and a low-speed member with linear slides is disclosed. The present invention provides a 2:1 reduction ratio without any gears, belts, chains, friction couplings, or other engaging members. Certain embodiments are balanced and may operate at high speed with little vibration. Pre-loaded rolling or self-lubricated joints may be used to eliminate backlash and the need for a lubrication system altogether. It is co-axial, does not slip, and may be produced using inexpensive materials, components, and manufacturing processes in both large and small form factors, due to the absence of any high-precision components. These advantages are well suited to applications which require high input speeds, low ratios, high efficiency, low complexity, high reliability and low cost.

### REFERENCE TO EARLIER FILED APPLICATIONS

This application makes reference to Patent Cooperation Treaty applications PCT/CA2015/050423, PCT/CA2015/050861, and PCT/CA2017/051439, and U.S. application U.S. Ser. No. 15/310,690.

This application claims priority to U.S. provisional application U.S. 62/455,484 filed Feb. 6, 2017. This patent application is incorporated herein entirely by reference.

### TECHNICAL FIELD

The disclosure herein relates to a speed reducer providing two members that rotate at different rates.

### BACKGROUND

A typical speed reducer comprises gears or other engaging members that are arranged to provide speed reduction between two rotating members. The three fundamental configurations include the offset, planetary and orbitless drives. Each provides a unique combination of advantages and disadvantages that relate to reduction ratio, compactness, efficiency, speed rating, backlash, noise, vibration, manufacturing cost, and other factors.

Additional derivative configurations include the worm, cycloid, strain wave and compound orbitless drive. Each of these also provides a trade-off between the factors identified above. Certain variations replace gear teeth with rolling elements to increase efficiency at the expense of added complexity, size and cost.

The present invention comprises linkages and joints that always remain in sliding or rolling contact. It does not comprise any gears or other engaging elements that may experience cogging or slippage. The absence of cogging results in high efficiency and low noise without the slippage of a friction coupling or the motion range limitation of a capstan cable coupling. Pre-loaded rolling or self-lubricated joints may be used to eliminate backlash and the need for a lubrication system altogether.

The present invention may be constructed using simple parts, conventional materials, and low-precision machining techniques due to the absence of small and/or high-precision elements such as gear teeth, timing belt cogs, or chain links. This makes it inexpensive to manufacture, even at a very large or small scale.

### SUMMARY

Certain exemplary embodiments comprise a reference member (79), a low-speed member (9), a high-speed member (19), and a linkage (21). The reference member (79) comprises a central axis (70) and an offset axis (71) which are substantially parallel and spaced apart. The low-speed member (9) comprises a central axis (0) and a radial axis (1) which are substantially perpendicular. The high-speed member (19) comprises a central axis (10) and an offset axis (11) which are substantially parallel and spaced apart. The central axis (70), central axis (0) and central axis (10) are all substantially co-axial and rotatably coupled (80,81). The linkage (21) comprises a first arm member (39), a second arm member (39), and an elongated member (59). Each arm member (39) comprises a proximal axis (30) and a distal axis (31) which are substantially parallel and spaced apart. The elongated member (59) comprises a central axis (50). One proximal axis (30) and the offset axis (71) are substantially co-axial and rotatably coupled (82). The other proximal axis (30) and the offset axis (11) are substantially co-axial and rotatably coupled (84). The central axis (50) and both distal axes (31) are all substantially co-axial. The central axis (50) and the first arm member (39) distal axis (31) are rotatably coupled (86). The central axis (50) and radial axis (1) are slidably coupled (89) along the radial axis (1).

In certain exemplary embodiments, the central axis (50) and the second arm member (39) distal axis (31) are rotatably coupled (87).

In certain exemplary embodiments, the elongated member (59) and the second arm member (39) are integral and the elongated member (59) and the low-speed member (9) are rotatably coupled (88) about the central axis (50).

In certain exemplary embodiments, the corresponding proximal axis (30) and distal axis (31) of all arm members (39) are spaced a common arm distance (90) apart, the central axis (70) and offset axis (71) are spaced an offset distance (91) apart, and the central axis (10) and offset axis (11) are spaced the offset distance (91) apart.

Certain exemplary embodiments comprise a plurality of linkages (21-25). The low-speed member (9) comprises a total number of radial axes (1) equal to the total number of linkages (21-25), all of which are substantially perpendicular to, and distributed radially around, the central axis (0). The central axis (50) of each linkage (21-25) and a different radial axis (1) are substantially perpendicular and slidably coupled (89) along each corresponding radial axis (1).

In certain exemplary embodiments, the reference member (79) comprises a total number of offset axes (71,72) less than or equal to the total number of linkages (21-25). All offset axes (71,72) are substantially parallel to, and arranged circumferentially around the central axis (70). At least one proximal axis (30) and each offset axis (71,72) are substantially co-axial and rotatably coupled (82,83).

In certain exemplary embodiments, the high-speed member (19) comprises a total number of offset axes (11-13) less than or equal to the total number of linkages (21-25). All offset axes (11-13) are substantially parallel to, and arranged circumferentially around the central axis (10). At least one proximal axis (30) and each offset axis (11-13) are substantially co-axial and rotatably coupled (84,85).

### BRIEF DESCRIPTION OF DRAWINGS

FIG. 1 is a schematic side view depicting a first exemplary embodiment of the present invention.

FIG. 2 is a schematic side view depicting a second exemplary embodiment of the present invention comprising two offset axes (71,72) and two linkages (21,22).

FIG. 3 is a schematic side view depicting a third exemplary embodiment of the present invention comprising two offset axes (11,12) and two linkages (21,23).

FIG. 4 is a schematic side view depicting a fourth exemplary embodiment of the present invention comprising two offset axes (71,72), two offset axes (11,12), and four linkages (21-24).

FIGS. 5A-5B are a collection of line drawings each depicting a front view of the first exemplary embodiment comprising one linkage (21), with its low-speed member (9) at incremental rotation angles spanning one full turn.

FIGS. 6A-6B are a collection of line drawings each depicting a front view of the third exemplary embodiment comprising two linkages (21,23), with its low-speed member (9) at incremental rotation angles spanning one full turn.

FIGS. 7A-7B are a collection of line drawings each depicting a front view of the third exemplary embodiment comprising three linkages (21,23,25), with its low-speed member (9) at incremental rotation angles spanning one full turn.

FIGS. 8A-8B are a collection of line drawings each depicting a front view of the fourth exemplary embodiment comprising four linkages (21-24), with its low-speed member (9) at incremental rotation angles spanning one full turn.

FIGS. 9A-9D are respectively, a partial cutaway perspective view, an exploded perspective view, a side section view, and a top section view depicting a first practical implementation of the fourth exemplary embodiment.

FIGS. 10A-10D are respectively, a partial cutaway perspective view, an exploded perspective view, a side section view, and a top section view depicting a second practical implementation of the fourth exemplary embodiment.

### REFERENCE NUMERALS

0—central axis
1—radial axis
9—low-speed member
10—central axis
11—first offset axis
12—second offset axis
13—third offset axis
19—high-speed member
21—linkage
22—linkage
23—linkage
24—linkage
25—linkage
30—proximal axis
31—distal axis
39—arm member
50—central axis
59—elongated member
70—central axis
71—first offset axis
72—second offset axis
79—reference member
80—rotatable coupling
81—rotatable coupling
82—rotatable coupling
83—rotatable coupling
84—rotatable coupling
85—rotatable coupling
86—rotatable coupling
87—rotatable coupling
88—rotatable coupling
89—slidable coupling
90—arm distance
91—offset distance
100—low-speed phase angle
101—high-speed phase angle
107—reference phase angle

### Definitions

An apparatus that transmits power between two rotating members is defined as a drive.

A drive that reduces velocity and amplifies torque is defined as a reduction drive.

A drive that amplifies velocity and reduces torque is defined as an over-drive.

A drive that may be operated as an over-drive is defined as back-drivable.

A drive that may not be operated as an over-drive is defined as self-locking.

A series combination of two or more drives is defined as a multi-stage drive.

Free-play between two engaged or coupled members is defined as backlash.

A rotating member with two or more parallel, non-coaxial axes is defined as a crankshaft.

### INTRODUCTION

Wherever possible, the same reference numeral is used throughout the accompanying drawings and description to refer to multiple instances of similar parts.

Components such as bearings, retainers and fasteners that do not substantially contribute to the understanding of the invention are neglected for the sake of simplicity.

Although a male shaft and female bore are used to depict a rotatable coupling in certain accompanying drawings, it is understood that any other means will suffice, such as an anti-friction bearing, a bushing, or any other type of joint comprising rolling elements, low friction coatings, materials, or lubricants. It is also understood that the male and female components of a rotatable coupling may often be interchanged.

Although a male shaft and female slot are used to depict a combined rotatable and slidable coupling in certain accompanying drawings, it is understood that any other means will suffice, such as a linear or recirculating ball bearing, a bushing, a track, a slide, a magnetic coupling, or any other type of joint comprising rolling elements, low friction coatings, materials, or lubricants. It is also understood that the male and female components of a slidable coupling may often be interchanged.

It is understood that when a plurality of rotatable couplings join a plurality of members about a common rotation axis, any member may be physically coupled to any other member and the male and female members of any rotatable coupling may be interchanged without substantially affecting operation.

Although the central axis (0) and all radial axes (1) are depicted as intersecting in certain accompanying drawings, it is understood that a slidable coupling may be translated in any direction without substantially affecting operation.

It is understood that a member comprising a plurality of radial axes (1) may include pairs of co-axial radial axes (1). Throughout the accompanying drawings and description, each radial axis (1) is treated as a separate radial axis (1) even if it is co-axial with another radial axis (1).

Although a shaft is used to depict a drive or driven member in certain accompanying drawings, it is understood that any other means will suffice, such as an engaging member, a keyed, splined, or threaded hole, or a magnetic or electrostatic coupling.

Although a uniform, flat bar is used to depict an arm member (39) in certain accompanying drawings, it is understood that any other shape will suffice, such as a circle, oval, square, rectangle, triangle, tetrahedron, or any other shape which may contain gaps, holes or indentations to provide clearance for other members. It is also understood that features such as ridges or channels may be included to improve stiffness or counter-balancing or to reduce vibration at high speeds.

Although no more than four linkages (21-25) are depicted in the accompanying drawings, it is understood that any number of linkages may be included, as long as they do not mechanically interfere.

Although all linkages (21-25) are depicted as substantially equivalent in certain accompanying drawings, it is understood that individual arm members (39) may have different arm distances (90), the reference member (79) or high-speed member (19) may comprise a plurality of different offset distances (91), and the low-speed member may have a central axis (0) and radial axes (1) that either do not intersect, or do not intersect at a common point, although non-linear or oscillatory behavior may result.

Although single-stage drives are depicted in the accompanying drawings, it is understood that multiple drives may be connected in series or in parallel and that the present invention may be combined with any other type of drive to obtain a desired speed ratio, offset, or other characteristic.

The present invention is typically back-drivable and may be operated as either a reduction drive or an over-drive by interchanging the roles of its high-speed (19) and low-speed members (9). In fact, the roles of the reference member (79), high-speed member (19) and low-speed member (9) may all be interchanged to obtain a desired reduction or over-drive ratio, or to cause the drive and driven members to rotate in the same or opposite directions. Similarly, if one is used as a drive member and the other two are used as driven members, a differential mechanism is obtained. Reduction, over-drive, differential, and reverse drives are all contemplated.

Due to the three dimensional nature of the present invention, certain arm members (39), elongated members (59) and radial axes (1) may be hidden, or only partially depicted in certain accompanying figures.

A representative sample of embodiments is included in the accompanying drawings for exemplary purposes only. A great number of additional kinematic arrangements are also contemplated. The scope of the present invention is not limited to the embodiments included but spans all possible combinations anticipated by the specification and claims.

### DESCRIPTION OF EMBODIMENTS

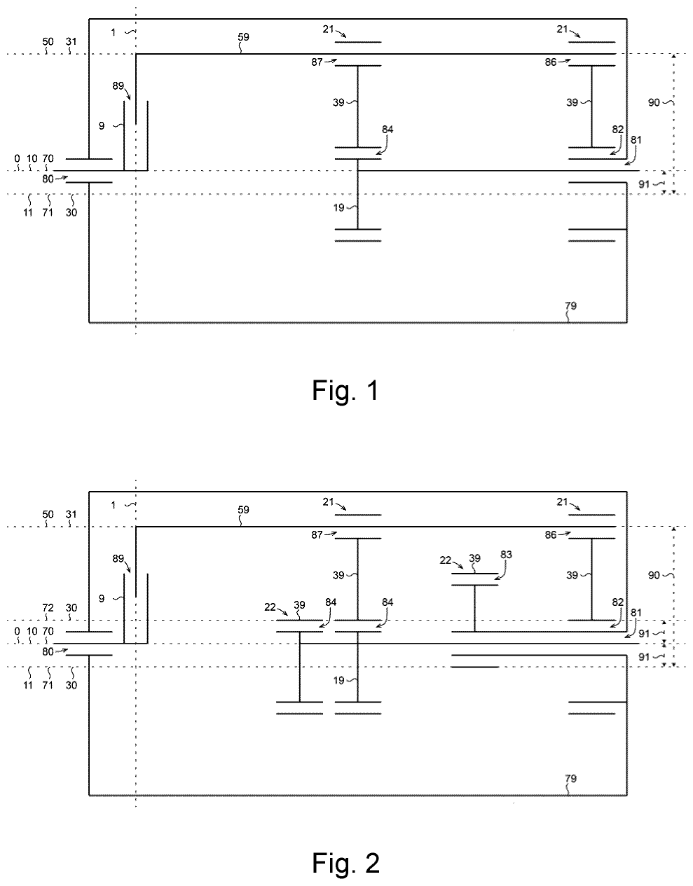

FIG. 1 illustrates a first exemplary embodiment of the present invention.

The first exemplary embodiment comprises a reference member (79), a low-speed member (9), a high-speed member (19), and a linkage (21).

The reference member (79) comprises a central axis (70) and an offset axis (71) which are substantially parallel and spaced an offset distance (91) apart.

The low-speed member (9) comprises a central axis (0) and a radial axis (1) which are substantially perpendicular and intersect.

The high-speed member (19) comprises a central axis (10) and an offset axis (11) which are substantially parallel and spaced the offset distance (91) apart.

The central axis (70), central axis (0) and central axis (10) are all substantially co-axial and rotatably coupled (80,81).

The linkage (21) comprises a first arm member (39), a second arm member (39), and an elongated member (59).

Each arm member (39) comprises a proximal axis (30) and a distal axis (31) which are substantially parallel and spaced an arm distance (90) apart.

The elongated member (59) comprises a central axis (50).

One proximal axis (30) and the offset axis (71) are substantially co-axial and rotatably coupled (82).

The other proximal axis (30) and the offset axis (11) are substantially co-axial and rotatably coupled (84).

The central axis (50) and both distal axes (31) are all substantially co-axial and rotatably coupled (86,87).

The central axis (50) and radial axis (1) are slidably coupled (89) along the radial axis (1).

FIG. 2 illustrates a second exemplary embodiment of the present invention.

The second exemplary embodiment comprises two linkages (21,22).

One linkage (22) and its associated radial axis (1) are substantially perpendicular to the plane of the illustration and are either hidden or only partially visible.

The low-speed member (9) comprises two radial axes (1), both of which are substantially perpendicular to the central axis (0), and to each other.

The central axis (50) of each linkage (21,22) and a different radial axis (1) are substantially perpendicular and slidably coupled (89) along the corresponding radial axis (1).

The reference member (79) comprises two offset axes (71,72) which are substantially parallel to, and arranged circumferentially around the central axis (70).

One proximal axis (30) of each linkage (21,22) and a different offset axis (71,72) are substantially co-axial and rotatably coupled (82,83).

The other proximal axis (30) of each linkage (21,22) and the offset axis (11) are all substantially co-axial and rotatably coupled (84).

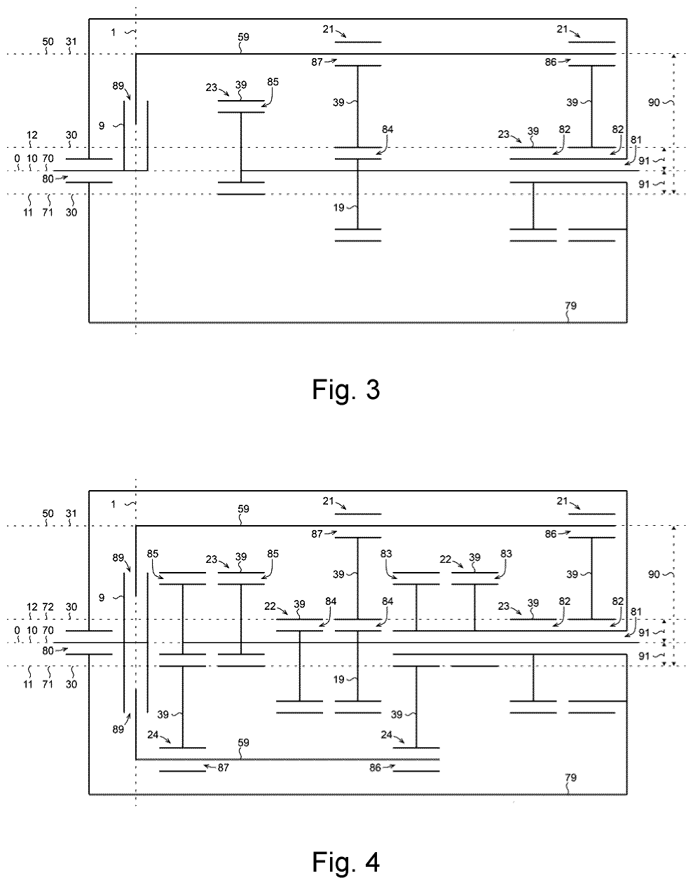

FIG. 3 illustrates a third exemplary embodiment of the present invention.

The third exemplary embodiment comprises two linkages (21,23).

One linkage (23) and its associated radial axis (1) are substantially perpendicular to the plane of the illustration and are either hidden or only partially visible.

The low-speed member (9) comprises two radial axes (1), both of which are substantially perpendicular to the central axis (0), and to each other.

The central axis (50) of each linkage (21,22) and a different radial axis (1) are substantially perpendicular and slidably coupled (89) along the corresponding radial axis (1).

The high-speed member (19) comprises two offset axes (11,12) which are substantially parallel to, and arranged circumferentially around the central axis (10).

One proximal axis (30) of each linkage (21,22) and a different offset axis (11,12) are substantially co-axial and rotatably coupled (84,85).

The other proximal axis (30) of each linkage (21,22) and the offset axis (71) are all substantially co-axial and rotatably coupled (82).

FIG. 4 illustrates a fourth exemplary embodiment of the present invention.

The fourth exemplary embodiment comprises four linkages (21-24).

Two linkages (22,23) and their associated radial axes (1) are substantially perpendicular to the plane of the illustration and are either hidden or only partially visible.

The low-speed member (9) comprises four radial axes (1), all of which are substantially perpendicular to the central axis (0), and to each other.

The central axis (50) of each linkage (21-24) and a different radial axis (1) are substantially perpendicular and slidably coupled (89) along the corresponding radial axis (1).

The reference member (79) comprises two offset axes (71,72) which are substantially parallel to, and arranged circumferentially around the central axis (70).

The high-speed member (19) comprises two offset axes (11,12) which are substantially parallel to, and arranged circumferentially around the central axis (10).

For the first linkage (21), one proximal axis (30) and the first offset axis (71) are substantially co-axial and rotatably coupled (82), and the other proximal axis (30) and the first offset axis (11) are substantially co-axial and rotatably coupled (84).

For the second linkage (22), one proximal axis (30) and the second offset axis (72) are substantially co-axial and rotatably coupled (83), and the other proximal axis (30) and the first offset axis (11) are substantially co-axial and rotatably coupled (84).

For the third linkage (23), one proximal axis (30) and the first offset axis (71) are substantially co-axial and rotatably coupled (82), and the other proximal axis (30) and the second offset axis (12) are substantially co-axial and rotatably coupled (85).

For the fourth linkage (24), one proximal axis (30) and the second offset axis (72) are substantially co-axial and rotatably coupled (83), and the other proximal axis (30) and the second offset axis (12) are substantially co-axial and rotatably coupled (85).

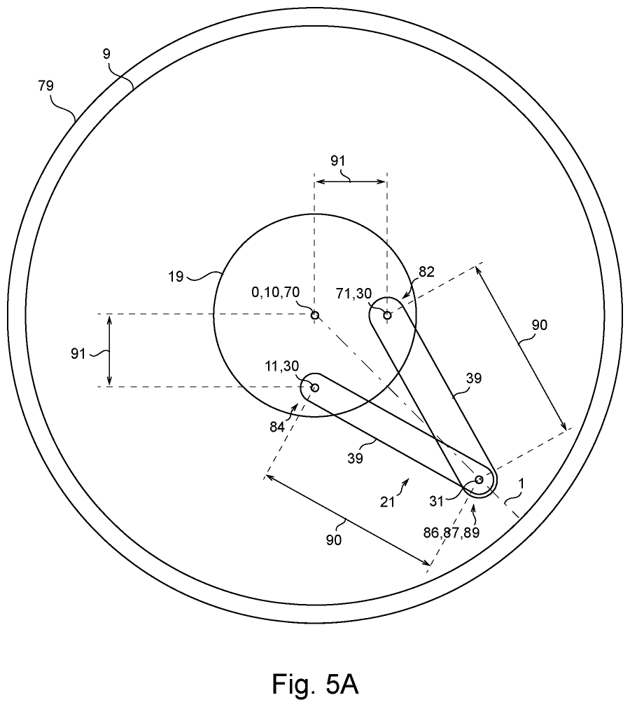

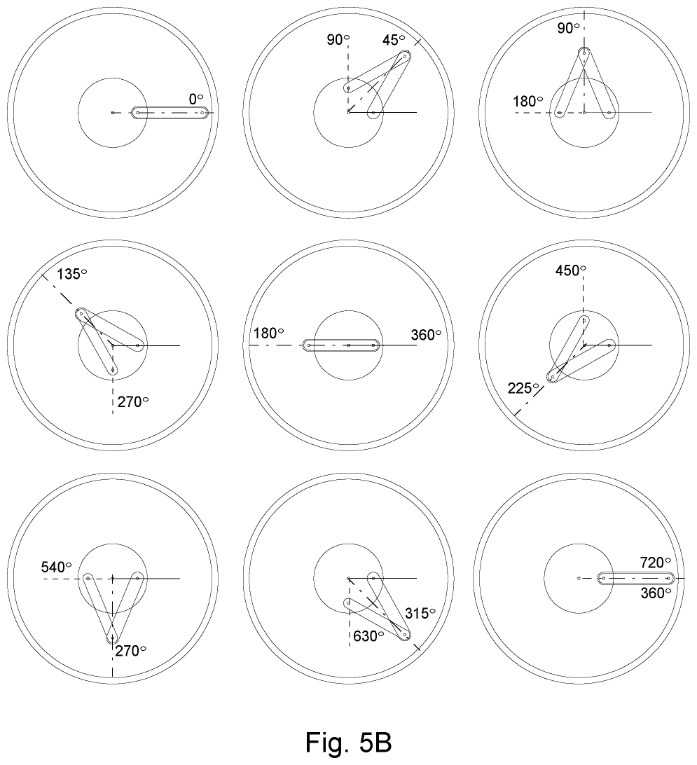

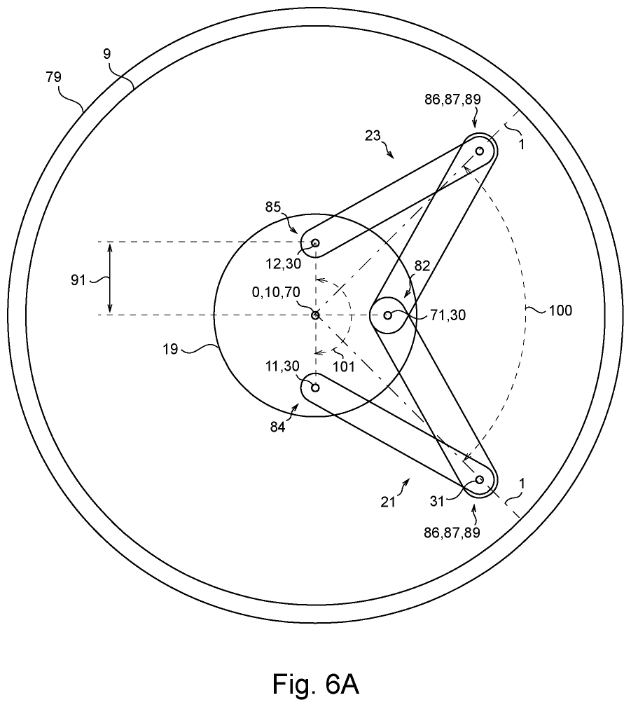

FIGS. 5A-5B depict the first exemplary embodiment comprising one linkage (21).

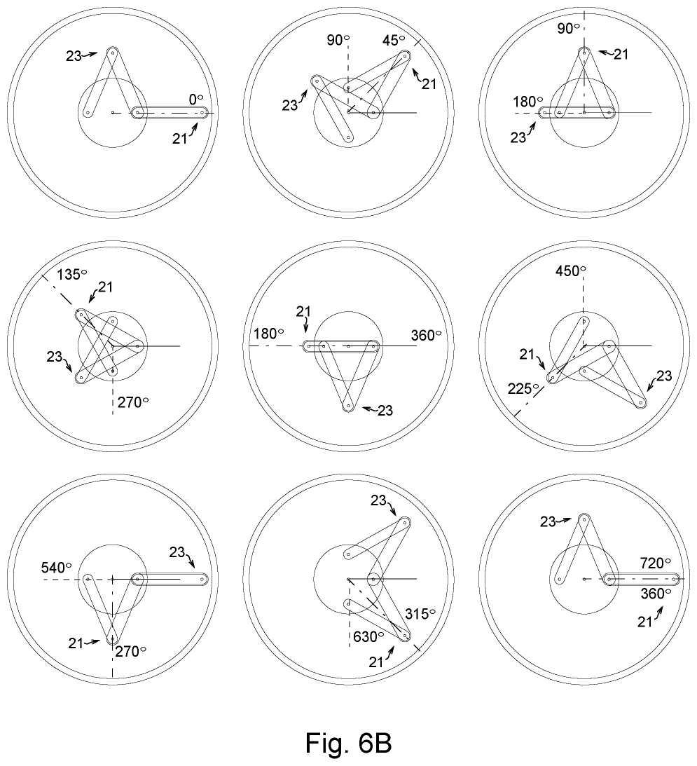

FIGS. 6A-6B depict the third exemplary embodiment comprising two linkage (21,23). The high-speed member (19) comprises two uniformly distributed (101) offset axes (11,12) and the low-speed member (9) comprises two non-uniformly distributed (100) radial axes (1).

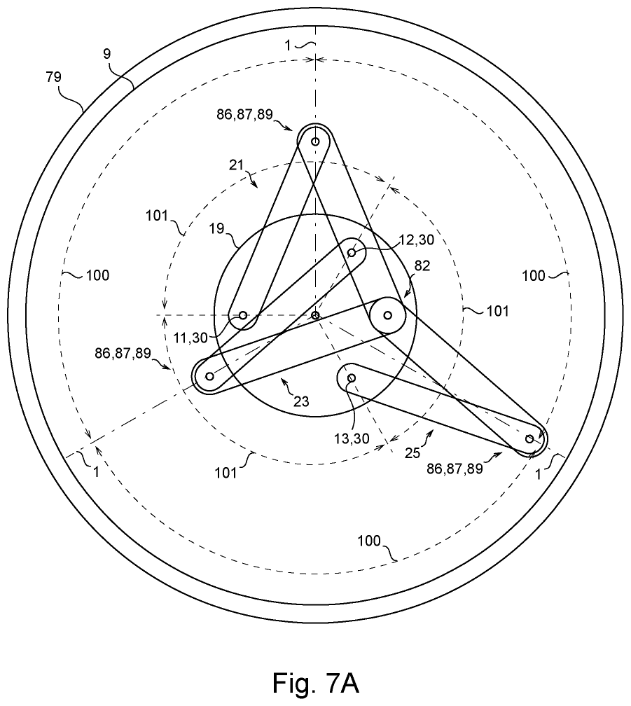

FIGS. 7A-7B depict the third exemplary embodiment comprising three linkage (21,23,25). The high-speed member (19) comprises three uniformly distributed (101) offset axes (11,12,13) and the low-speed member (9) comprises three uniformly distributed (100) radial axes (1).

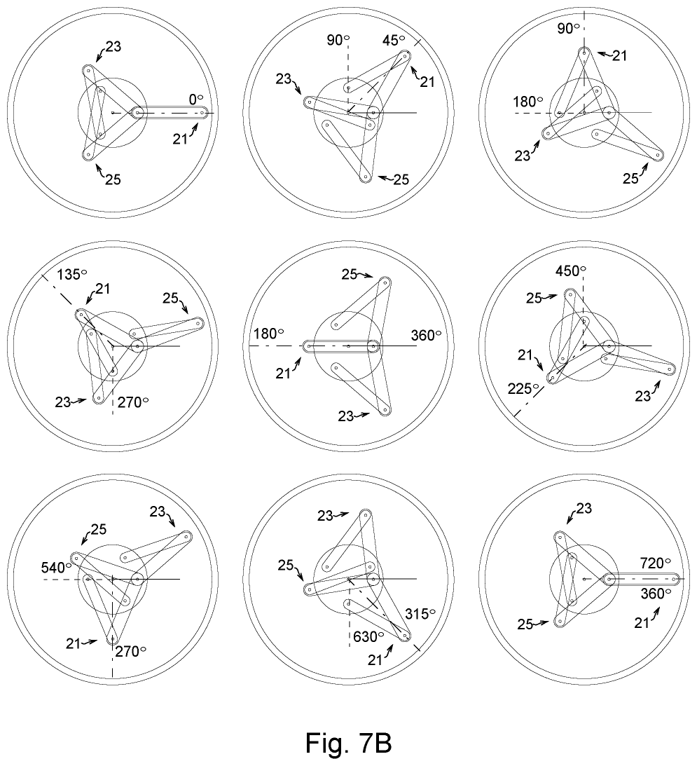

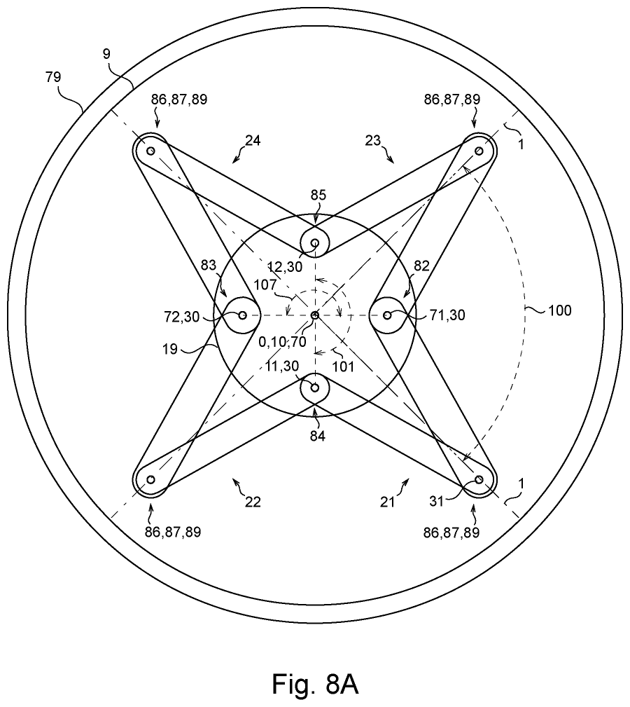

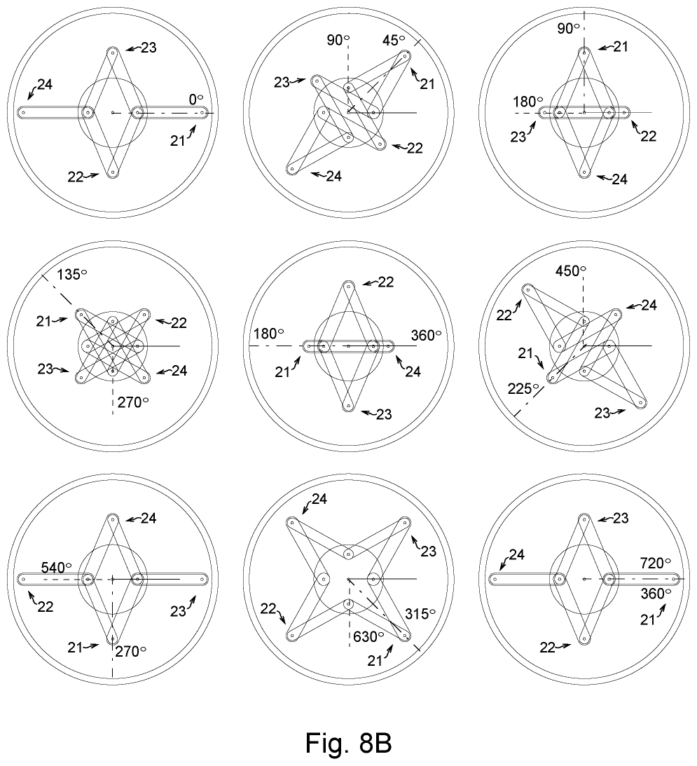

FIGS. 8A-8B depict the fourth exemplary embodiment comprising four linkage (21-24). The high-speed member (19) comprises two uniformly distributed (101) offset axes (11,12), the reference member (79) comprises two uniformly distributed (107) offset axes (71,72), and the low-speed member (9) comprises four uniformly distributed (100) radial axes (1).

In FIGS. 5B, 6B, 7B and 8B, the low-speed member (9) is depicted at nine different rotation angles that progress in 45° increments to span one full turn (360°), and the high-speed member (19) is depicted at nine different rotation angles that progress in 90° increments to span two full turns (720°).

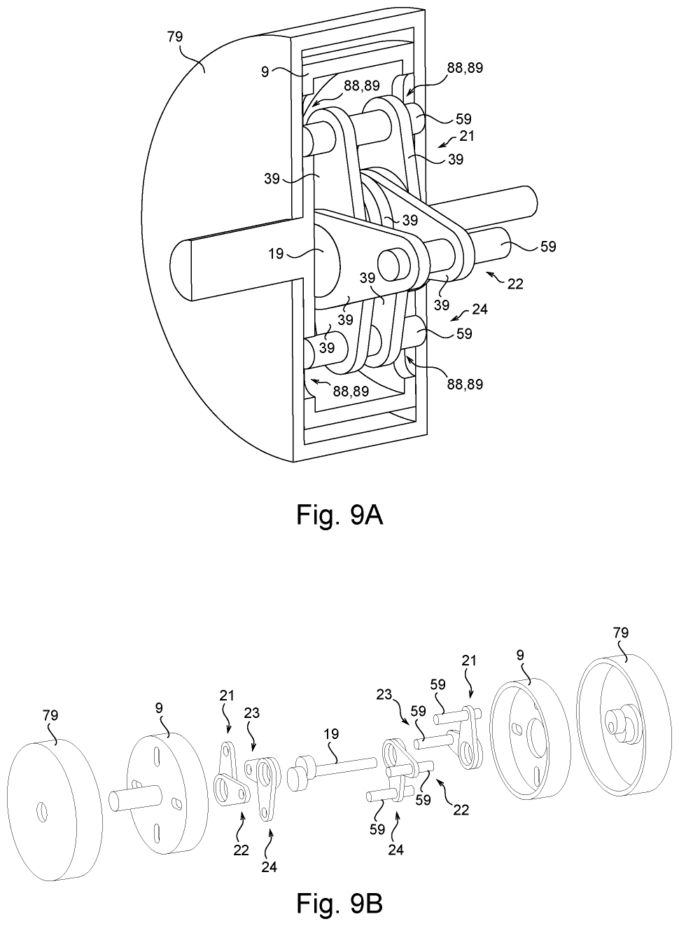

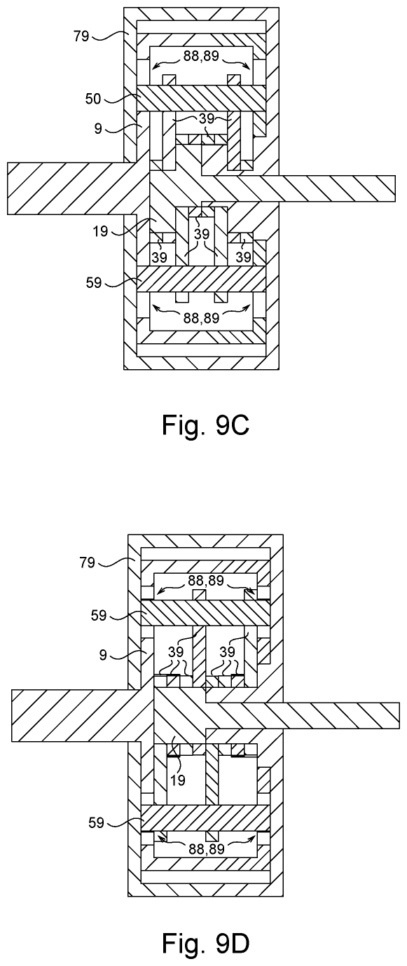

FIGS. 9A-9D depict a first practical implementation of the fourth exemplary embodiment.

As illustrated in FIG. 9B, each of the four linkages (21-24) comprises an elongated member (59) and second arm member (39) that are integral.

Each elongated member (59) and the low-speed member (9) are simultaneously rotatably coupled (88) about the corresponding central axis (50), and slidably coupled (89) about the corresponding radial axis (1), by a rod (59) engaging a pair of slots that are located on opposite sides of the linkages (21-24).

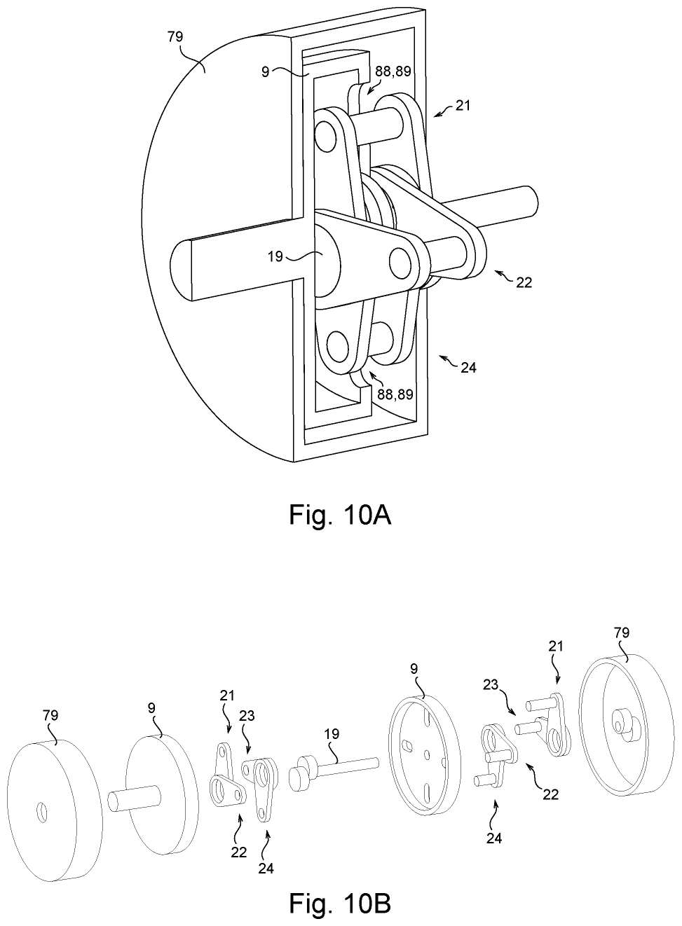

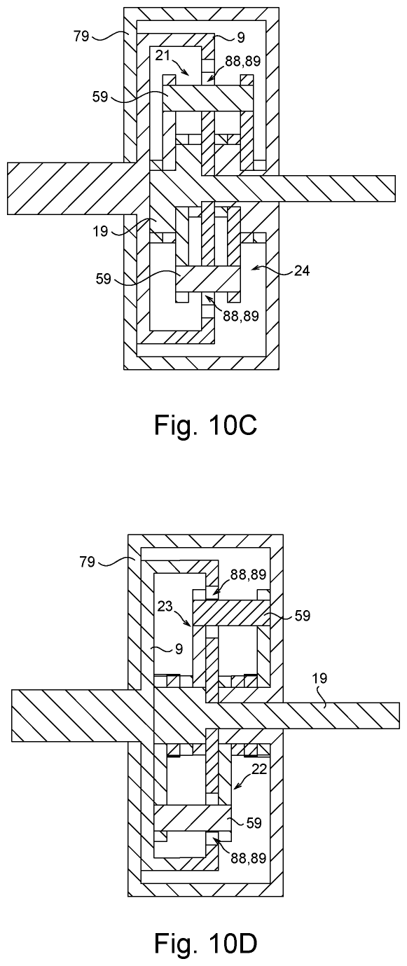

FIGS. 10A-10D depict a second practical implementation of the fourth exemplary embodiment.

As illustrated in FIG. 10B, each of the four linkages (21-24) comprises an elongated member (59) and second arm member (39) that are integral.

Each elongated member (59) and the low-speed member (9) are simultaneously rotatably coupled (88) about the corresponding central axis (50), and slidably coupled (89) about the corresponding radial axis (1), by a rod (59) engaging a single slot that is located between the two arm members (39) of the linkages (21-24).

### EXAMPLES

In each of the following examples, a reduction ratio of 2:1 is provided whereby two complete turns of the high-speed member (19) results in one complete turn of the low-speed member (9), in the same direction, with respect to the reference member (79).

If the low-speed member (9) is held fixed, the high-speed member (19) and reference member (79) rotate in unison, but in opposite directions.

Any time the two arm members (39) of a linkage (21-25) are aligned, that linkage (21-25) is in a singular configuration.

A first example considers the first exemplary embodiment illustrated in FIGS. 5A-5B which contains a single linkage (21).

In FIG. 5B, high-speed member (19) angles of 0°, 360° and 720° place the linkage (21) into a singular configuration which may result in unpredictable behavior and should be avoided in practice by including mechanical stops or other means.

A second example considers the third exemplary embodiment illustrated in FIGS. 6A-6B which contains two linkages (21,23), two radial axes (1) separated by a low-speed phase angle (100) of 90°, and two offset axes (11,12) separated by a high-speed phase angle (101) of 180°.

In FIG. 6B, high-speed member (19) angles of 0°, 360° and 720° place the first linkage (21) into a singular configuration, and high-speed member (19) angles of 180° and 540° place the second linkage (23) into a singular configuration.

Never are both linkages (21,23) simultaneously in a singular configuration so the apparatus behaves predictably at all times.

A third example considers the third exemplary embodiment illustrated in FIGS. 7A-7B which contains three linkages (21,23,25), three radial axes (1) each separated by a common low-speed phase angle (100) of 120°, and three offset axis (11,12,13) each separated by a common high-speed phase angle (101) of 120°.

In FIG. 7B, high-speed member (19) angles of 0°, 360° and 720° place the first linkage (21) into a singular configuration, high-speed member (19) angles of 120° and 480° (not shown) place the second linkage (23) into a singular configuration, and high-speed member (19) angles of 240° and 600° (not shown) place the third linkage (25) into a singular configuration.

Never are all three linkages (21,23,25) simultaneously in a singular configuration so the apparatus behaves predictably at all times.

Due to its improved symmetry, the third example produces less vibration than the second example at high speeds.

A fourth example considers the fourth exemplary embodiment illustrated in FIGS. 8A-8B which contains four linkages (21-24), four radial axes (1) each separated by a common low-speed phase angle (100) of 90°, two offset axes (11,12) separated by a high-speed phase angle (101) of 180°, and two offset axes (71,72) separated by a reference phase angle (107) of 180°.

In FIG. 8B, high-speed member (19) angles of 0°, 360° and 720° place the first linkage (21) and fourth linkage (24) into a singular configuration, and high-speed member (19) angles of 180° and 540° place the second linkage (22) and third linkage (23) into a singular configuration.

Never are all four linkages (21-24) simultaneously in a singular configuration so the apparatus behaves predictably at all times.

Due to its improved symmetry, the fourth example provides less vibration than the second or third examples at high speeds.

A fifth example considers the first practical implementation illustrated in FIGS. 9A-9D.

In FIGS. 9A-9D, the low-speed member (9) sandwiches the linkages (21-24) with a combined slidable (89) and rotatable (88) coupling located at both ends of the elongated members (59), thereby distributing the forces and minimizing the torque acting on them.

A sixth example considers the second practical implementation illustrated in FIGS. 10A-10D.

In FIGS. 10A-10D, the low-speed member (9) bisects the linkages (21-24) with a combined slidable (89) and rotatable (88) coupling, thereby locating the force between the two arm members (39) of each linkage (21-24) and minimizing the torque acting on the elongated members (59).

### Advantages

The exemplary embodiments disclosed herein have a number of advantageous properties.

Certain exemplary embodiments do not comprise any gears or any other engaging elements and do not produce any gear noise or vibration.

Certain exemplary embodiments do not slip.

Certain exemplary embodiments provide zero backlash between the low-speed member (9) and high-speed member (19) without any compliance.

Certain exemplary embodiments comprise co-axial input and output shafts.

Certain exemplary embodiments provide an unlimited rotary motion range.

Certain exemplary embodiments are balanced and develop little vibration at high speeds.

Certain exemplary embodiments provide high efficiency.

Certain exemplary embodiments provide a high torque capacity.

Certain exemplary embodiments may be constructed using inexpensive materials, components and manufacturing processes.

Certain exemplary embodiments require no lubricant or lubrication system.

Certain exemplary embodiments are back-drivable and may be configured to provide a reduction ratio, an overdrive ratio, or a direction reversal.

Other advantages are apparent from the disclosure herein.

1. An apparatus comprising a reference member (79), a low-speed member (9), a high-speed member (19), and a linkage (21), wherein:
the reference member (79) comprises a central axis (70) and an offset axis (71) which are substantially parallel and spaced apart;
the low-speed member (9) comprises a central axis (0) and a radial axis (1) which are substantially perpendicular;
the high-speed member (19) comprises a central axis (10) and an offset axis (11) which are substantially parallel and spaced apart;
the central axis (70), central axis (0) and central axis (10) are all substantially co-axial and rotatably coupled (80,81);
the linkage (21) comprises a first arm member (39), a second arm member (39), and an elongated member (59);
each arm member (39) comprises a proximal axis (30) and a distal axis (31) which are substantially parallel and spaced apart;
the elongated member (59) comprises a central axis (50);
one proximal axis (30) and the offset axis (71) are substantially co-axial and rotatably coupled (82);
the other proximal axis (30) and the offset axis (11) are substantially co-axial and rotatably coupled (84);
the central axis (50) and both distal axes (31) are all substantially co-axial;
the central axis (50) and the first arm member (39) distal axis (31) are rotatably coupled (86);
and the central axis (50) and radial axis (1) are slidably coupled (89) along the radial axis (1).

2. The apparatus of claim 1 wherein the central axis (50) and the second arm member (39) distal axis (31) are rotatably coupled (87).

3. The apparatus of claim 1 wherein:
the elongated member (59) and the second arm member (39) are integral;
and the elongated member (59) and the low-speed member (9) are rotatably coupled (88) about the central axis (50).

4. The apparatus of claim 1 wherein:
the corresponding proximal axis (30) and distal axis (31) of all arm members (39) are spaced a common arm distance (90) apart;
the central axis (70) and offset axis (71) are spaced an offset distance (91) apart;
and the central axis (10) and offset axis (11) are spaced the offset distance (91) apart.

5. The apparatus of claim 1 comprising a plurality of linkages (21-25), and wherein:
the low-speed member (9) comprises a total number of radial axes (1) equal to the total number of linkages (21-25), all of which are substantially perpendicular to, and distributed radially around, the central axis (0);
and the central axis (50) of each linkage (21-25) and a different radial axis (1) are substantially perpendicular and slidably coupled (89) along each corresponding radial axis (1).

6. The apparatus of claim 5 wherein:
the reference member (79) comprises a total number of offset axes (71,72) less than or equal to the total number of linkages (21-25);
all offset axes (71,72) are substantially parallel to, and arranged circumferentially around the central axis (70);
and at least one proximal axis (30) and each offset axis (71,72) are substantially co-axial and rotatably coupled (82,83).

7. The apparatus of claim 5 wherein:
the high-speed member (19) comprises a total number of offset axes (11-13) less than or equal to the total number of linkages (21-25);
all offset axes (11-13) are substantially parallel to, and arranged circumferentially around the central axis (10);
and at least one proximal axis (30) and each offset axis (11-13) are substantially co-axial and rotatably coupled (84,85).

8. A method comprising:
providing a reference member (79), a low-speed member (9), a high-speed member (19), and a linkage (21);
providing the reference member (79) with a central axis (70) and an offset axis (71) which are substantially parallel and spaced apart;
providing the low-speed member (9) with a central axis (0) and a radial axis (1) which are substantially perpendicular;
providing the high-speed member (19) with a central axis (10) and an offset axis (11) which are substantially parallel and spaced apart;
locating the central axis (70), central axis (0) and central axis (10) such that they are all substantially co-axial, and rotatably coupling (80,81) them;
providing the linkage (21) with a first arm member (39), a second arm member (39), and an elongated member (59);
providing each arm member (39) with a proximal axis (30) and a distal axis (31) which are substantially parallel and spaced apart;
providing the elongated member (59) with a central axis (50);
locating one proximal axis (30) and the offset axis (71) such that they are substantially co-axial, and rotatably coupling (82) them;
locating the other proximal axis (30) and the offset axis (11) such that they are substantially co-axial, and rotatably coupling (84) them;
locating the central axis (50) and both distal axes (31) such that they are all substantially co-axial;
rotatably coupling (86) the central axis (50) and the first arm member (39) distal axis (31);
and slidably coupling (89) the central axis (50) and radial axis (1) along the radial axis (1).

9. The method of claim 8 further rotatably coupling (87) the central axis (50) and the second arm member (39) distal axis (31).

10. The method of claim 8 further:
integrating the elongated member (59) and the second arm member (39);
and rotatably coupling (88) the elongated member (59) and the low-speed member (9) about the central axis (50).

11. The method of claim 8 further:
locating the corresponding proximal axis (30) and distal axis (31) of all arm members (39) such that they are spaced a common arm distance (90) apart;
locating the central axis (70) and offset axis (71) such that they are spaced an offset distance (91) apart;
and locating the central axis (10) and offset axis (11) such that they are spaced the offset distance (91) apart.

12. The method of claim 8 further:
providing one or more additional linkages (22-25);
providing the low-speed member (9) with a total number of radial axes (1) equal to the total number of linkages (21-25), all of which are substantially perpendicular to, and distributed radially around, the central axis (0);
and locating the central axis (50) of each linkage (21-25) and a different radial axis (1) such that they are substantially perpendicular, and slidably coupling (89) them along each corresponding radial axis (1).

13. The method of claim 12 further:
providing the reference member (79) with a total number of offset axes (71,72) less than or equal to the total number of linkages (21-25);
locating all offset axes (71,72) such that they are substantially parallel to, and arranged circumferentially around the central axis (70);
and locating at least one proximal axis (30) and each offset axis (71,72) such that they are substantially co-axial, and rotatably coupling (82,83) them.

14. The method of claim 12 further:
providing the high-speed member (19) with a total number of offset axes (11-13) less than or equal to the total number of linkages (21-25);
locating all offset axes (11-13) such that they are substantially parallel to, and arranged circumferentially around the central axis (10);
and locating at least one proximal axis (30) and each offset axis (11-13) such that they are substantially co-axial, and rotatably coupling (84,85) them.
